(19) United States
(12) Patent Application Publication
(10) Pub. No.: US 2025/0356020 A1
(43) Pub. Date: Nov. 20, 2025

(54) TECHNOLOGIES TO TRACK FIRMWARE SOURCES

(71) Applicant: Intel Corporation, Santa Clara, CA (US)

(72) Inventors: Elena AGRANOVSKY, Jerusalem (IL); Eli KUPERMANN, Ma’ale Adumim (IL); Nikola RADOVANOVIC, Los Altos, CA (US)

(21) Appl. No.: 19/290,711

(22) Filed: Aug. 5, 2025

(51) Int. Cl. G06F 21/57; G06F 8/65

(52) U.S. Cl. CPC G06F 21/572; G06F 8/65; G06F 2221/033

(57) ABSTRACT

Examples described herein relate to tracking identification of firmware providers to identify unauthorized firmware providers. For example, prior to sharing device secret data with a firmware provider, circuitry can store an identification of the firmware provider in one time programmable (OTP) memory to record the identifier of the firmware provider.

Hardware devices execute firmware as a bridge between the device and an operating system (OS) to allow the OS to interact with the hardware. Devices update their firmware to enhance security, improve performance, and add new features. Firmware updates address vulnerabilities, fix bugs, and adjust how hardware components work together. However, during manufacture of a device, firmware can be loaded by an unauthorized entity and execution of the firmware can lead to unauthorized access to data or cause the device or a system that utilizes the device to malfunction.

### BRIEF DESCRIPTION OF THE DRAWINGS

FIG. 1 depicts an example process.

FIG. 2 depicts an example system.

FIG. 3 depicts an example process.

FIG. 4 depicts an example process.

FIG. 5 depicts an example computing system.

### DETAILED DESCRIPTION

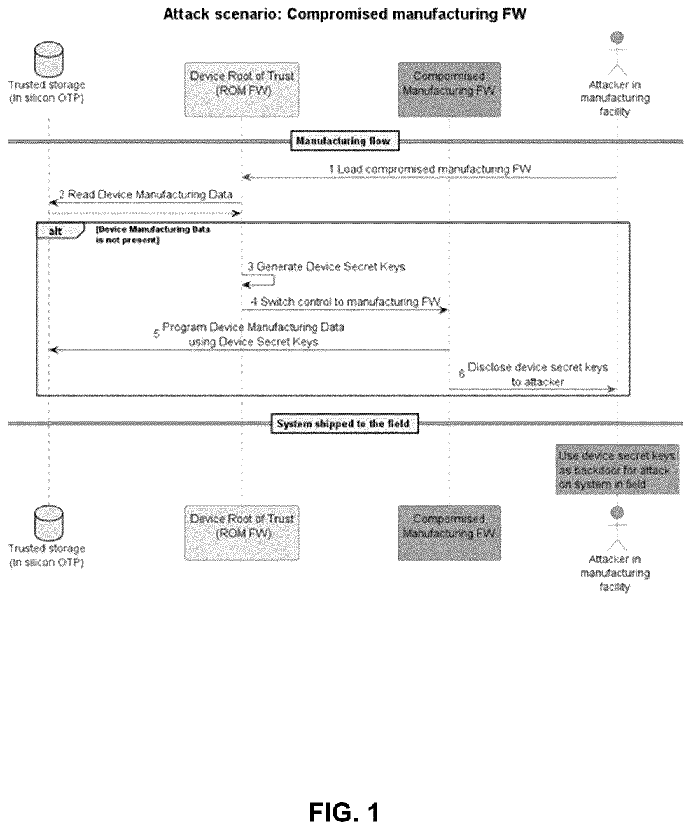

FIG. 1 depicts an example scenario of firmware loading in Original Design Manufacturer (ODM) or Original Equipment Manufacturer (OEM) environments. At (1), manufacturing firmware (FW) is loaded by an attacker to a computer system. At (2), root of trust (ROT) firmware (FW) can request to read device manufacturing data from one time programmable memory (OTP). Device manufacturing data can include device settings created during a manufacturing of the device. If device manufacturing data is not provisioned, at (3), ROT firmware generates device secret keys. In an attack scenario, an attacker replaces manufacturing firmware with compromised firmware. At (4), ROT firmware provides secret keys to the compromised manufacturing firmware. At (5) compromised manufacturing firmware uses device secret keys to create device manufacturing data and store the device manufacturing data to memory. At (6), compromised manufacturing firmware exposes the device secret keys to the attacker. Device secret keys exposed to attacker in operation (6) can be used to constitute attack on system in the field. However, when the attacker replaces compromised manufacturing firmware with approved manufacturing firmware, there is no trail of attack or exposure of the device secret keys. An attacker may use device secret keys to create security backdoors to break into Original Equipment Manufacturer (OEM) systems in the field of use after manufacturing and access secret data or cause the device to malfunction.

At least to address vulnerabilities introduced by installing firmware in computer systems in ODM or OEM environments, various examples can trace an identity of a manufacturer that installed firmware used during system manufacturing. Various examples can program a manufacturing firmware identity to one time programmable (OTP) memory as a pre-condition to providing security services such as secret keys. For example, without manufacturing firmware identity being programmed to OTP, a device does not provide full security services to a requester by blocking creation of keys and secrets used for security functionality when booting. A device root of trust can verify that a manufacturing firmware identifier matches the identity programmed to OTP before sharing device secret keys with a requester. If an untrusted or unrecognized source is identified in OTP, a device can be identified as compromised, an OEM or ODM can be identified as storing unauthorized firmware, and/or the device can potentially store unauthorized or unapproved firmware.

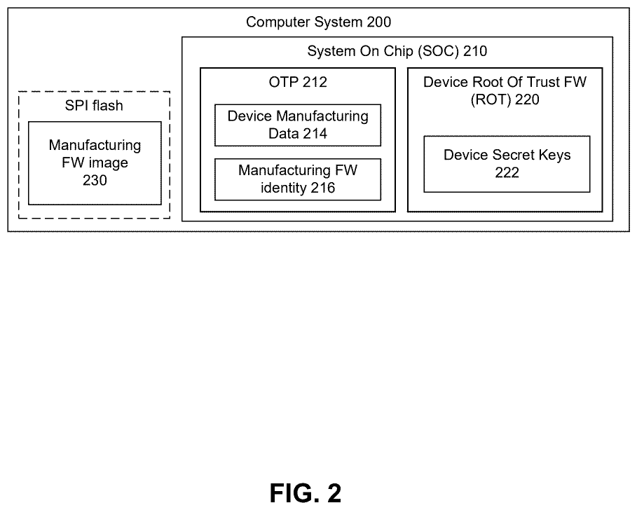

FIG. 2 depicts an example system. System on chip (SOC) 210 can include One Time Programmable Non-Volatile Memory (OTP) 212, that once programmed, cannot be modified. Various examples of OTP 212 can include fuses, array of fuses, or others. OTP 212 can store at least device manufacturing data 214 and manufacturing firmware (FW) identity 216.

Device manufacturing data 214 can include device settings created during a manufacturing of SoC 210 using device secret keys 222. Device manufacturing data 214 can vary per type of manufactured device and can include second level protection keys. If device secret keys 222 are exposed to an attacker, the attacker could re-create a secret portion of the device second level protection keys and use it to modify data protected by those keys. Another example of device manufacturing data 214 includes device security policies.

In some examples, device manufacturing data 214 is created by transferring settings from SPI flash to OTP 210.

Manufacturing FW identity 216 can include information identifying an entity that loaded manufacturing FW image 230 into Serial Peripheral Interface (SPI) flash of system 200. As described herein, storage of a source of manufacturing FW image 230 can be required prior to accessing device secret keys 222.

Device Root of Trust FW (ROT) 220 can include a privileged FW module executed in a boot process of SoC 210. ROT 220 can perform tasks such as secure boot to ensure that only trusted code runs at startup, key management, and attestation to prove the system's trustworthiness to other devices or software. In some examples, ROT 220 can include a security engine (e.g., Secure Startup Services Module (S3M)) that creates device secret keys 222 used to convert a format of SPI flash stored data. When SoC 210 boots for the first time, ROT 220 can generate storage keys used to transfer security settings from SPI flash into in-package security storage as part of a commit flow to make a firmware update permanent after a device has successfully booted with the updated firmware. An ROT can be implemented as one or more of: a microprocessor that executes instructions, firmware, application specific integrated circuit (ASIC), field programmable gate array (FPGA), or other circuitry.

Device secret keys 222 can include cryptographic keys used during manufacturing of SoC 210. If exposed to an attacker might be used to constitute an attack on device in the field.

Manufacturing FW image 230 can be accessed during boot of SoC 202. Manufacturing FW image 230 can be FW used during computer manufacturing. Manufacturing FW image 230 can receive device secret keys 222 and can create device manufacturing data 214 using device secret keys 222 and storing device manufacturing data 214 in OTP 212.

In some examples, firmware code or firmware can include one or more of: Basic Input/Output System (BIOS), Universal Extensible Firmware Interface (UEFI), or a boot loader. The BIOS firmware can be pre-installed on a personal computer's system board or accessible through an SPI interface from a boot storage (e.g., flash memory). In some examples, firmware can include SPS. In some examples, a Universal Extensible Firmware Interface (UEFI) can be used instead or in addition to a BIOS for booting or restarting cores or processors. UEFI is a specification that defines a software interface between an operating system and platform firmware. UEFI can read from entries from disk partitions by not just booting from a disk or storage but booting from a specific boot loader in a specific location on a specific disk or storage. UEFI can support remote diagnostics and repair of computers, even with no operating system installed. A boot loader can be written for UEFI and can be instructions that a boot code firmware can execute and the boot loader is to boot the operating system(s). A UEFI bootloader can be a bootloader capable of reading from a UEFI type firmware.

A UEFI capsule is a manner of encapsulating a binary image for firmware code updates. But in some examples, the UEFI capsule is used to update a runtime component of the firmware code. The UEFI capsule can include updatable binary images with relocatable Portable Executable (PE) file format for executable or dynamic linked library (dll) files based on COFF (Common Object File Format). For example, the UEFI capsule can include executable (*.exe) files. This UEFI capsule can be deployed to a target platform as an SMM image via existing OS specific techniques (e.g., Windows Update for Azure, or LVFS for Linux).

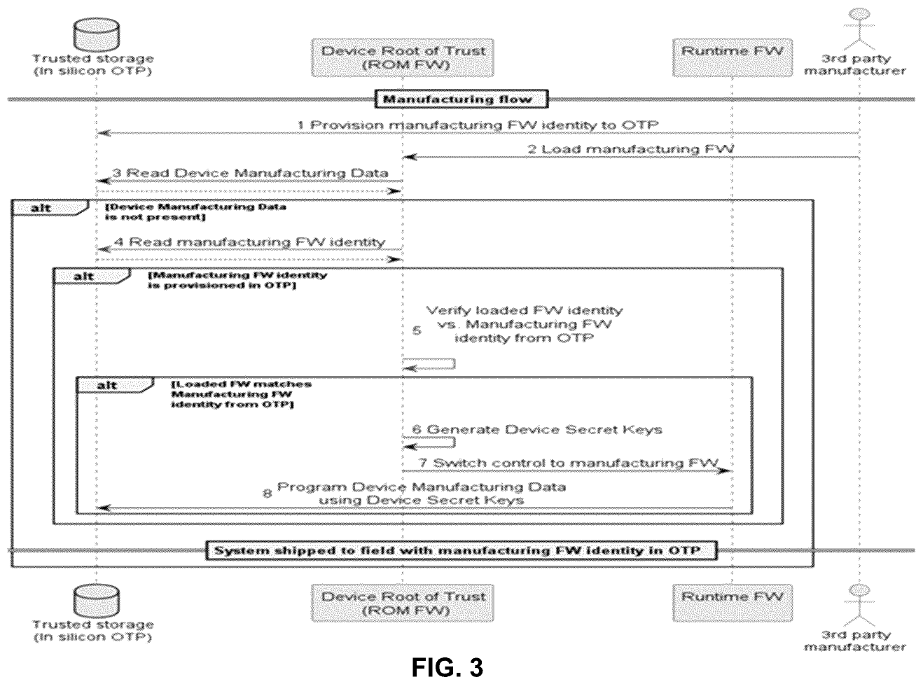

FIG. 3 depicts an example manufacturing flow. At (1), manufacturing FW identity is provisioned by a manufacturer (e.g., OEM or ODM) in OTP. At (2), the manufacturer loads manufacturing FW to the computer system memory (e.g., SPI flash). At (3), ROT FW requests device manufacturing data from OTP. At (4), if device manufacturing data is not stored or available from OTP, ROT FW fetches the manufacturing FW identity stored in OTP. At (5), ROT FW verifies that the manufacturing FW identity from the manufacturer matches the manufacturing FW identity stored in OTP. If the identity of the manufacturer matches the manufacturing FW identity stored in OTP, the check passes, and at (6), ROT FW generates device secret keys. At (7), ROT FW switches control to manufacturing FW, providing manufacturing FW with device secret leys. At (8), manufacturing FW uses device secret keys to create device manufacturing data and stores device manufacturing data in OTP. Thereafter, system is shipped to the field.

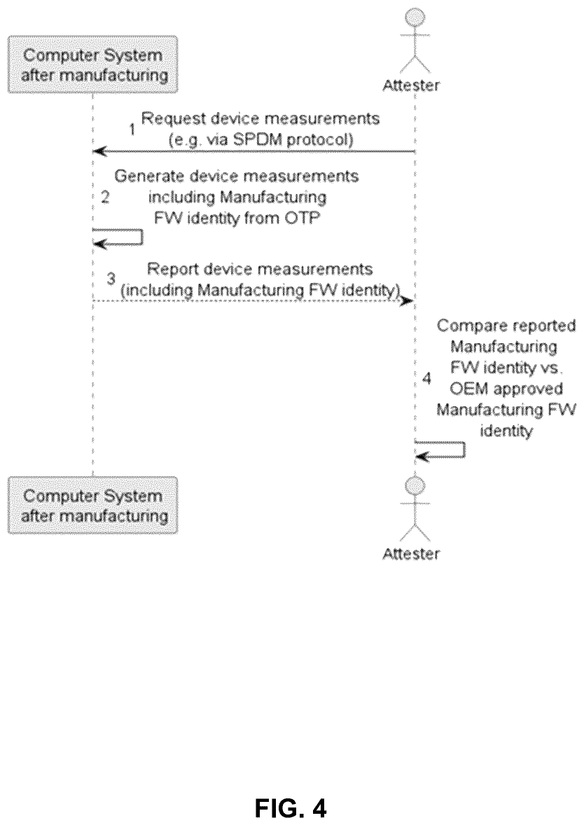

FIG. 4 depicts an example attestation flow. After manufacture of an SoC, an attestation flow is used to trace identity of manufacturer to identify sources of firmware loaded in the SoC. At (1), an attester requests device measurements from computer system FW. Various attestation protocols and message constructs can be used including Intel Security Libraries for Datacenter (SecL-D), Intel CPU Attestation, DMTF's Security Protocols and Data Models (SPDM), Internet Engineering Task Force (IETF) attestation protocols, or others. At (2), computer system FW uses credentials provided by ROT FW to report device measurements including manufacturing FW identity. At (3), attester checks information to confirm that manufacturing FW identity matches approved by OEM manufacturing FW identifies. If there no match, then the attester can shut down the system, not grant network/other access to the platform that fails attestation, or inform a data center administrator. If there is a match between the manufacturing FW identity, stored in OTP and provided as a condition to accessing device keys, and matches approved by OEM manufacturing FW identifies, the device is identified as storing authorized firmware.

While examples are described with respect to tracking firmware updates, technologies can be used to track providers of any type of software, including: applications, operating system (OS), driver, bug fixes, security updates, version updates, or others.

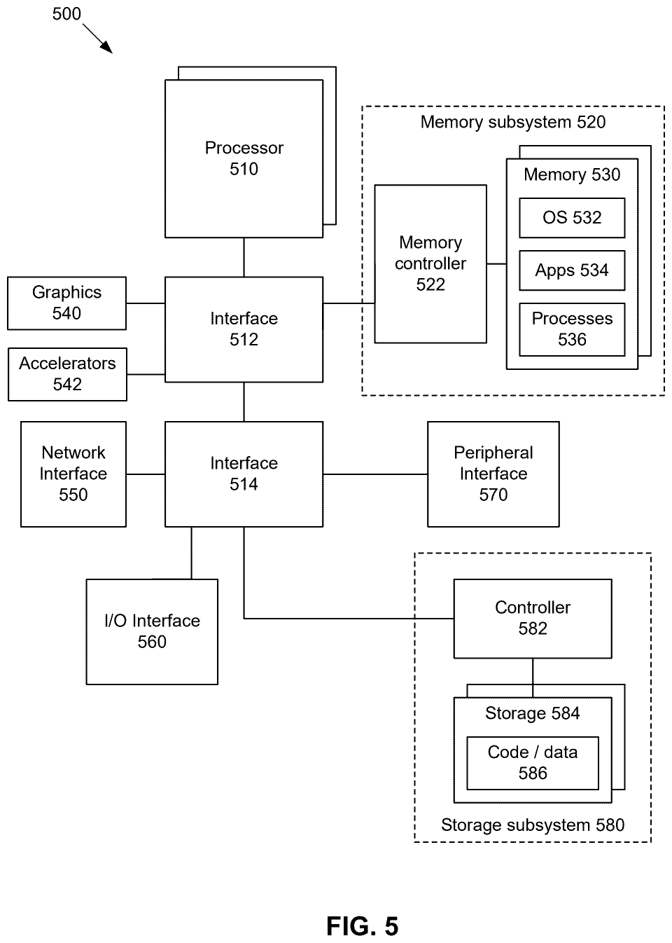

FIG. 5 depicts a system. The system can use examples to identify a provider of firmware for various circuitries of system 500 (e.g., processor 510, graphics 540, one or more of accelerators 542, and/or network interface 550), as described herein. System 500 includes processor 510, which provides processing, operation management, and execution of instructions for system 500. Processor 510 can include any type of microprocessor, central processing unit (CPU), graphics processing unit (GPU), processing core, or other processing hardware to provide processing for system 500, or a combination of processors. Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die.

Accelerators 542 can be a fixed function or programmable offload engine that can be accessed or used by a processor 510. For example, an accelerator among accelerators 542 can provide data compression (DC) capability, cryptography services such as public key encryption (PKE), cipher, hash/authentication capabilities, decryption, or other capabilities or services. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 542 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as static random-access memory (SRAM), dynamic random-access memory (DRAM), or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

In some examples, OS 532 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. In some examples, network interface 550 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory.

Some examples of network interface 550 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 550 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONIC), Broadcom® Network Programming Language (NPL), NVIDIA® CUDAR, NVIDIA® DOCA™, Data Plane Development Kit (DPDK), OpenDataPlane (ODP), Infrastructure Programmer Development Kit (IPDK), x86 compatible executable binaries or other executable binaries, or others.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory is memory whose state (and therefore the data stored in it) is indeterminate if power is interrupted to the device. A non-volatile memory (NVM) device is a memory whose state is determinate even if power is interrupted to the device.

In an example, system 500 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chipset-to-chipset communications, die-to-die communications, packet-based communications, communications over a device interface (e.g., PCIe, CXL, UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes an apparatus that includes an interface and circuitry to: prior to sharing device secret data with a firmware provider, store an identification of the firmware provider in one time programmable (OTP) memory to record the identifier of the firmware provider.

Example 2 includes one or more examples, wherein: based on the identifier of the firmware provider not corresponding to an approved firmware provider, identify an unauthorized firmware provider and shut down the device and/or deny input/output (I/O) access to the device.

Example 3 includes one or more examples, wherein: based on the identifier of the firmware provider corresponding to an approved firmware provider, identify the firmware provider as authorized.

Example 4 includes one or more examples, wherein the circuitry is to: permit access to keys based on prior storage of the firmware provider identifier in the OTP.

Example 5 includes one or more examples, wherein the firmware provider is to generate a second level key based on the keys.

Example 6 includes one or more examples, wherein the circuitry is to: generate storage keys used to transfer security settings from flash to in-package security storage as part of a successful boot of a firmware update.

Example 7 includes one or more examples, wherein: the firmware provider is to store firmware for access by the device.

Example 8 includes one or more examples, wherein the device comprises one or more of: a network interface device, a processor, or an accelerator, wherein the device is to execute firmware of the firmware provider.

Example 9 includes one or more examples, wherein the circuitry comprises a root of trust.

Example 10 includes one or more examples, and includes a method that includes: identifying an installer of firmware on a device by: storing an identifier of the installer in one time programmable (OTP) memory and based on a matching of the identifier of the installer stored in the OTP memory with an identifier of the installer, providing a secret asset of the device to the installer.

Example 11 includes one or more examples, wherein the device comprises one or more of: a network interface device, a processor, or an accelerator.

Example 12 includes one or more examples, and includes identifying an unauthorized firmware provider based on the identifier of the installer not matching an approved firmware provider identifier and based on identification of the unauthorized firmware provider, shutting down the device that executes the firmware and/or not granting input/output (I/O) access to the device.

Example 13 includes one or more examples, and includes identifying an authorized firmware provider based on the identifier of the installer matching an approved firmware provider identifier.

Example 14 includes one or more examples, wherein the secret asset comprises a cryptographic key and comprising generating and storing device data based on the cryptographic key.

Example 15 includes one or more examples, and includes at least one non-transitory computer-readable medium comprising instructions stored thereon, that when executed by one or more circuitry, cause the one or more circuitry to: prior to sharing device secret data of a device, store a firmware provider identifier in one time programmable (OTP) memory to identify a firmware provider.

Example 16 includes one or more examples, and includes instructions stored thereon, that when executed by one or more circuitry, cause the one or more circuitry to: identify an unauthorized firmware provider based on the identifier of the firmware provider not matching an approved firmware provider identifier and based on identification of the unauthorized firmware provider, shut down the device and/or deny input/output (I/O) access to the device.

Example 17 includes one or more examples, and includes instructions stored thereon, that when executed by one or more circuitry, cause the one or more circuitry to: identify an authorized firmware provider based on the identifier of the firmware provider matching an approved firmware provider identifier.

Example 18 includes one or more examples, wherein the secret data comprises a cryptographic key and comprising generating and storing device data based on the cryptographic key.

1. An apparatus comprising:
an interface and
circuitry to:
prior to sharing device secret data with a firmware provider, store an identification of the firmware provider in one time programmable (OTP) memory to record the identifier of the firmware provider.

2. The apparatus of claim 1, wherein:
based on the identifier of the firmware provider not corresponding to an approved firmware provider, identify an unauthorized firmware provider and shut down the device and/or deny input/output (I/O) access to the device.

3. The apparatus of claim 1, wherein:
based on the identifier of the firmware provider corresponding to an approved firmware provider, identify the firmware provider as authorized.

4. The apparatus of claim 1, wherein the circuitry is to:
permit access to keys based on prior storage of the firmware provider identifier in the OTP.

5. The apparatus of claim 4, wherein the firmware provider is to generate a second level key based on the keys.

6. The apparatus of claim 1, wherein the circuitry is to:
generate storage keys used to transfer security settings from flash to in-package security storage as part of a successful boot of a firmware update.

7. The apparatus of claim 1, wherein:
the firmware provider is to store firmware for access by the device.

8. The apparatus of claim 7, wherein the device comprises one or more of: a network interface device, a processor, or an accelerator, wherein the device is to execute firmware of the firmware provider.

9. The apparatus of claim 1, wherein the circuitry comprises a root of trust.

10. A method comprising:
identifying an installer of firmware on a device by:
storing an identifier of the installer in one time programmable (OTP) memory and
based on a matching of the identifier of the installer stored in the OTP memory with an identifier of the installer, providing a secret asset of the device to the installer.

11. The method of claim 10, wherein the device comprises one or more of: a network interface device, a processor, or an accelerator.

12. The method of claim 10, comprising:
identifying an unauthorized firmware provider based on the identifier of the installer not matching an approved firmware provider identifier and
based on identification of the unauthorized firmware provider, shutting down the device that executes the firmware and/or not granting input/output (I/O) access to the device.

13. The method of claim 10, comprising:
identifying an authorized firmware provider based on the identifier of the installer matching an approved firmware provider identifier.

14. The method of claim 10, wherein the secret asset comprises a cryptographic key and comprising generating and storing device data based on the cryptographic key.

15. At least one non-transitory computer-readable medium comprising instructions stored thereon, that when executed by one or more circuitry, cause the one or more circuitry to:
prior to sharing device secret data of a device, store a firmware provider identifier in one time programmable (OTP) memory to identify a firmware provider.

16. The computer-readable medium of claim 15, comprising instructions stored thereon, that when executed by one or more circuitry, cause the one or more circuitry to:
identify an unauthorized firmware provider based on the identifier of the firmware provider not matching an approved firmware provider identifier and
based on identification of the unauthorized firmware provider, shut down the device and/or deny input/output (I/O) access to the device.

17. The computer-readable medium of claim 15, comprising instructions stored thereon, that when executed by one or more circuitry, cause the one or more circuitry to:
identify an authorized firmware provider based on the identifier of the firmware provider matching an approved firmware provider identifier.

18. The computer-readable medium of claim 15, wherein the secret data comprises a cryptographic key and comprising generating and storing device data based on the cryptographic key.
